(19) United States
(12) Patent Application Publication
(10) Pub. No.: US 2018/0253644 A1
(43) Pub. Date: Sep. 6, 2018

(54) IDENTIFYING ELECTRICAL DEVICES USING ARTIFICIAL NEURAL NETWORKS

(71) Applicant: BRITE THINGS, INC., Oakland, CA (US)

(72) Inventors: Liangcai TAN, Dublin, CA (US); Xin HU, Dublin, CA (US); Michael WILSON, Oakland, CA (US)

(73) Assignee: BRITE THINGS, INC., Oakland, CA (US)

(21) Appl. No.: 15/446,433

(22) Filed: Mar. 1, 2017

(51) Int. Cl. G06N 3/08

(52) U.S. Cl. CPC G06N 3/08

(57) ABSTRACT

Described are methods and systems for identifying an electrical load device electrically coupled to a smart plug device. In some embodiments, a server receives, from the smart plug device, a plurality of power properties associated with the electrical load device. The server inputs the plurality of power properties into a plurality of nodes of an artificial neural network (ANN) graph to generate a predicted device ID. The server queries a database for a device ID that is within a threshold of the predicted device ID. Based on querying the database to determine that the device ID exists, the server identifies the electrical load device as a device associated with the device ID.

### FIELD OF THE DISCLOSURE

The present disclosure relates to artificial intelligence and, more specifically, to identifying electrically-coupled electrical load devices using an artificial neural network.

### BACKGROUND OF THE DISCLOSURE

Many devices in use today such as appliances (e.g., microwaves and dishwashers, etc.) and electronics (stereo equipment, televisions, chargers, laptops, etc.) consume electrical power. These devices tend to consume power whether they are in use, idle, or turned off as long as they are plugged into a power source, e.g., an electrical outlet. In fact, according to the U.S. Department of Energy, around 75 percent of the energy used by devices in homes is when the devices are turned off by users. This phenomenon, sometimes referred to as standby power or vampire power, occurs because many devices that are turned off are in standby mode. While in standby mode, a device may be detecting signals, e.g., from a button or a remote, to quickly return to an active mode.

Therefore, to save energy costs and reduce standby power consumption, device users may have to physically unplug appliances, electronics, and other devices from electrical outlets when the devices are not in use. This approach is inconvenient and not very practical.

Additionally, users such as homeowners or facility managers are interested in identifying devices in their homes or facilities that consume lots of power to reduce their energy usage and reduce greenhouse gas emissions. For example, a user may identify a device that is energy inefficient and replace the identified device with a more energy efficient device. Alternatively, the user may implement strategies for reducing the power consumption of energy-inefficient devices.

To identify plugged-in electrical devices, research studies have been conducted that involve a device user using an oscilloscope to read power signatures of electrical devices. Based on the power signature readings, the user may compare the readings with device specifications to identify the device. This approach is not scalable for a large number of devices typically operating within a home or an office building and cannot be performed in real time.

### BRIEF DESCRIPTIONS OF THE DRAWINGS

FIG. 1 illustrates a system that utilizes an artificial neural network to identify electrical load devices, according to some embodiments.

FIG. 2 illustrates a flowchart of a method for generating a power signature, according to some embodiments.

FIG. 3 illustrates a flowchart of a method for using an artificial neural network to identify electrically-coupled electrical load devices, according to some embodiments.

FIG. 4 illustrates a flowchart of a method for training an artificial neural network implemented by a server to identify electrically-coupled electrical load devices, according to some embodiments.

FIG. 5 is a diagram showing an example artificial neural network used to identify an electrically-coupled electrical load device, according to some embodiments.

FIG. 6 illustrates an exemplary computing device, according to some embodiments.

### DETAILED DESCRIPTION

As discussed above, using oscilloscopes to manually and individually identify the types of devices operating in a building to generate energy management strategies is impractical and inefficient. To improve upon these inefficient methods, described are systems and methods for automatically identifying electrically-coupled electrical load devices and generating energy management strategies to reduce energy consumption of identified electrical load device. In some embodiments, to automatically identify electrical load devices, i.e., devices that consume electrical power, a system includes smart plug devices that generate power signatures of electrical load devices electrically coupled to the smart plug devices. These smart plug devices may communicate with a server implementing an artificial neural network (ANN) to automatically and in real time identify the electrical load devices coupled to the smart plug devices.

By implementing the ANN, the server may identify similar electrical load devices that are plugged into different smart plug devices based on data collected and received from the smart plug devices. Further, the server may identify new electrical load devices based on previously-identified electrical load devices. In some embodiments, by automatically and in real time identifying which electrical load devices are being used at different locations and times, the server implementing the ANN can generate and send energy management strategies to the smart plug devices to help users, such as homeowners or facilities managers, to reduce energy consumption. In some embodiments, an energy management strategy generated by the server can be an operating schedule instructing a smart plug to disconnect or reconnect one or more electrical load devices from a power source.

In some embodiments, the server implementing the ANN can be configured as a cloud-based system to enable users to view analysis results, e.g., device identification, or energy management strategies generated by the server, from a variety of network-enabled devices, e.g., a mobile phone or a laptop. For example, a user may access a web browser, a web application, or a native application on his or her network-enabled device to view the analysis results. In some embodiments, analysis results can include energy consumption metrics and ratings of identified electrical load devices. A facilities manager, for example, may review the analysis results on his network-enabled device to determine the best logistics plan to save cost or whether to upgrade facilities equipment to extend equipment life and reduce energy costs.

In the following description of the disclosure and embodiments, reference is made to the accompanying drawings in which are shown, by way of illustration, specific embodiments that can be practiced. It is to be understood that other embodiments and examples can be practiced, and changes can be made without departing from the scope of the disclosure.

In addition, it is also to be understood that the singular forms “a,” “an,” and “the,” used in the following description, are intended to include the plural forms as well, unless the context clearly indicates otherwise. It is also to be understood that the term “and/or,” as used herein, refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of processes and symbolic representations of operations on data bits within a computer memory. These process and symbolic representations are the means used by those skilled in the data-processing arts to most effectively convey the substance of their work to others skilled in the art. A process is generally conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise, as apparent from the following discussion, it is appreciated that, throughout the description, discussions utilizing terms such as “processing,” “computing,” “calculating,” “determining,” “displaying,” or the like refer to the actions and processes of a computer system or similar electronic computing device that manipulates and transforms data represented as physical (electronic) quantities within the computer system memories or registers or other such information storage, transmission, or display devices.

Certain aspects of the present disclosure include steps and instructions described herein in the form of a process. It should be noted that the steps and instructions of the present disclosure can be embodied in software, firmware, or hardware and, when embodied in software, can be downloaded to reside on and be operated from different operating systems used by a variety of computing devices.

The present disclosure also relates to a device for performing the operations herein. This device may be specially constructed for the required purposes, or it may comprise a general-purpose computer selectively activated or reconfigured by a computer program stored in the computer. Such a computer program may be stored in a non-transitory, computer-readable storage medium, such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions and coupled to a computer system bus. Furthermore, the computers referred to in this disclosure may include a single processor or include multiple processors to increase computing capability.

The methods, devices, and systems described herein are not inherently related to any particular computer or other apparatus. Various general-purpose systems may be used with programs in accordance with the teachings herein, or it may prove convenient to construct more specialized apparatus to perform the required method steps. The required structure for a variety of these systems will be described below. In addition, the present disclosure is not described with reference to any particular programming language. It will be appreciated by a person of ordinary skill in the relevant arts that a variety of programming languages may be used to implement the teachings of the present disclosure as described herein.

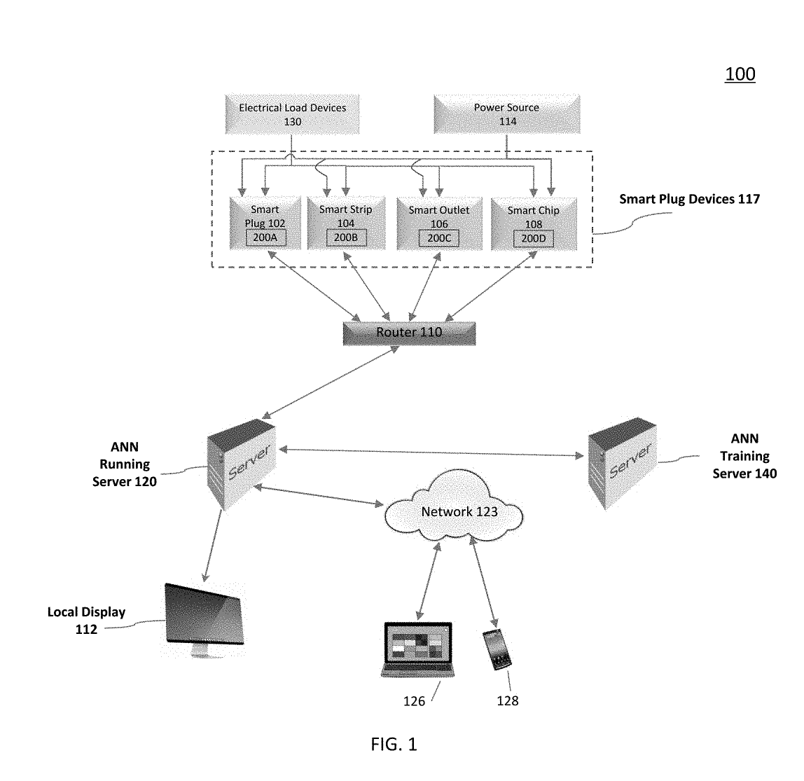

FIG. 1 illustrates a system 100 that utilizes an artificial neural network (ANN) to identify electrical load devices 130, according to some embodiments. System 100 includes electrical load devices 130 that can be individually coupled to any of smart plug devices 117 to access power source 114. As an example, power source 114 may represent mains electricity generated by a power plant. Electrical load devices 130 are devices that include one or more circuits that consume electric power. For example, electrical load devices 130 may include electrical appliances, lights, and other electronics. In some embodiments, electrical load devices 130 can be electrically coupled to, e.g., by plugging into, any of smart plug devices 117. As shown in system 100, smart plug devices 117 may include a smart plug 102, a smart strip 104, a smart outlet 106, or a smart chip 108. A smart plug 102 may include, for example, one power socket. A smart outlet 106 may include, for example, two power sockets. A smart strip 104 may include a plurality of power sockets, e.g., three or more power sockets. A smart chip 108 may include, for example, a power supply module attached to electrical appliances.

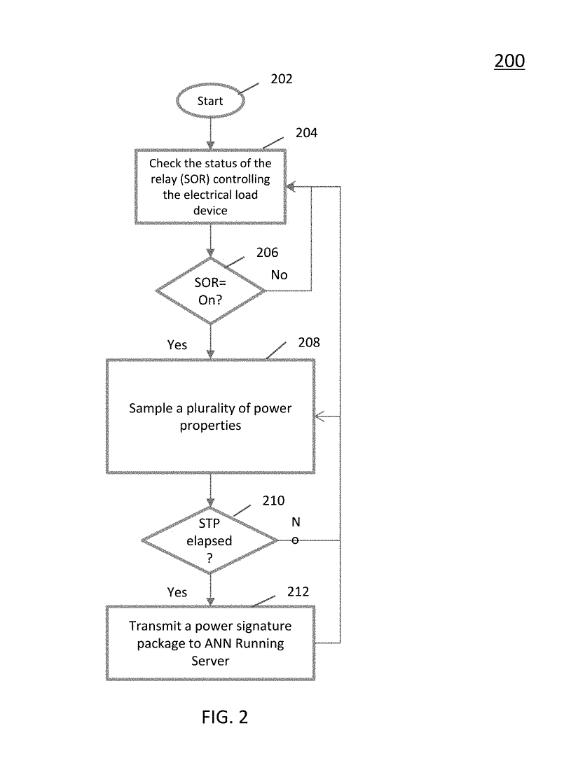

In some embodiments, system 100 can include smart plug devices 117 that enable electrical load devices 130 to connect to and draw power from power source 114. For example, electrical load devices 130A-D are plugged in to smart plug 102, smart strip 104, smart outlet 106, and smart chip 108, respectively. In some embodiments, to enable smart plug devices 117 to identify a type of a respectively, coupled electrical load device 130A-D, smart plug 102, smart strip 104, smart outlet 106, and smart chip 108 include power signature generators 200A-D, respectively. Power signature generators 200A-D, as further described with respect to FIG. 2, can be configured to collect power signatures of electrically-coupled electrical load devices 130A-D and execute power control instructions to control access of respective connected electrical load devices 130 to power source 114.

System 100 can include a router 110 that routes wired or wireless communications between smart plug devices 117 and an ANN running server 120. According to some embodiments, ANN running server 120 may include one or more servers to implement and operate an ANN to facilitate energy saving operations of electrically-coupled electrical load devices 130. In some embodiments, based on information generated by power signature generators 200A-D and received from one or more smart plug devices 117, ANN running server 120 can utilize the ANN to recognize power signatures, identify devices, categorize user behavior, and generate operating schedules to reduce energy consumption of electrical load devices.

In some embodiments, based on the analysis performed by ANN running server 120, ANN running server 120 may send control commands to one or more smart plug devices 117 via router 110. For example, ANN running server 120 may generate the control commands based on user behavior, inactivity periods of electrical load devices 130, a property of electrical load devices 130, when an electrical load device 130 is in a standby mode, among other power signature information generated by power signature generator 200A-D.

By operating according to the control commands, smart plug devices 117 can form an intelligent load control system with learning capabilities and automatic optimization functions to help users of electrical load devices 130 to cut energy use, energy cost, and greenhouse gas emission. For example, a control command may instruct one or more smart plug devices 117 to electrically disconnect and reconnect plugged-in electrical load devices 130 for different time periods or at future times.

In some embodiments, by instantly identifying the type of electrical load devices 130 plugged into smart plug devices 117, ANN running server 120 can rapidly determine energy usage optimization based on the same or similar devices previously connected to smart plug devices 117. In some embodiments, to identify a type of electrically coupled electrical load devices 130, ANN running server 120 may generate a predicted device identification (ID) based on the power signature information received from power signature generators 200A-D. Then, ANN running server 120 may query a database storing a plurality of device IDs based on the predicted device ID. Further, ANN running server 120 may generate an operating schedule or device usage recommendation for an electrical load device based on whether a device ID is successfully queried in the database and based on device information associated with the device ID stored in the database as well as past power signature information associated with the electrical load device.

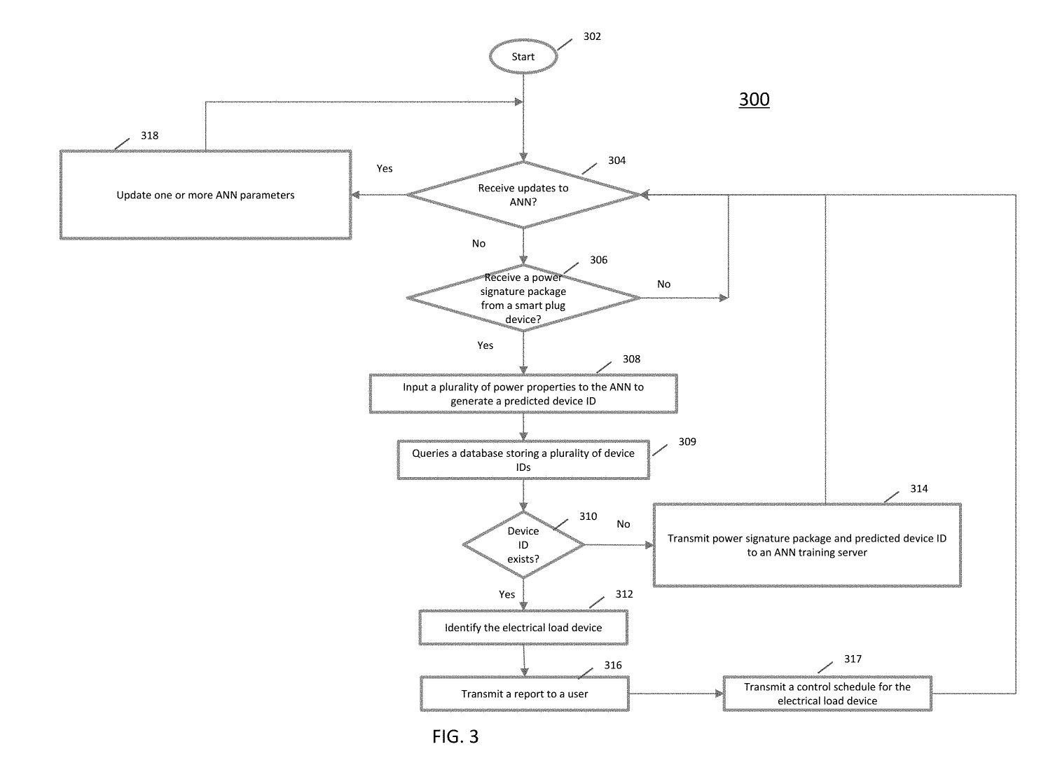

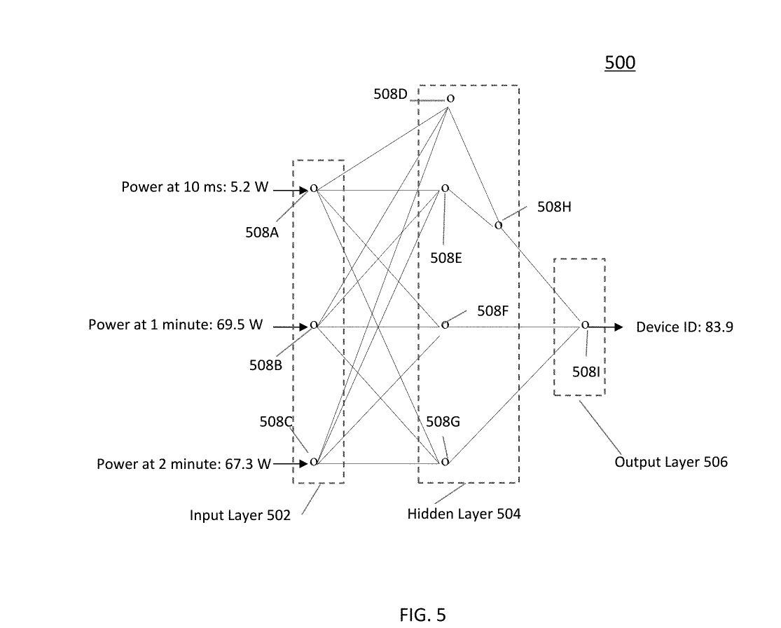

In some embodiments, to analyze user behavior or power usage of electrical load devices 130 to identify electrical load devices 130 and generate control strategies, ANN running server 120 can implement an ANN as further described with respect to FIGS. 3 and 5.

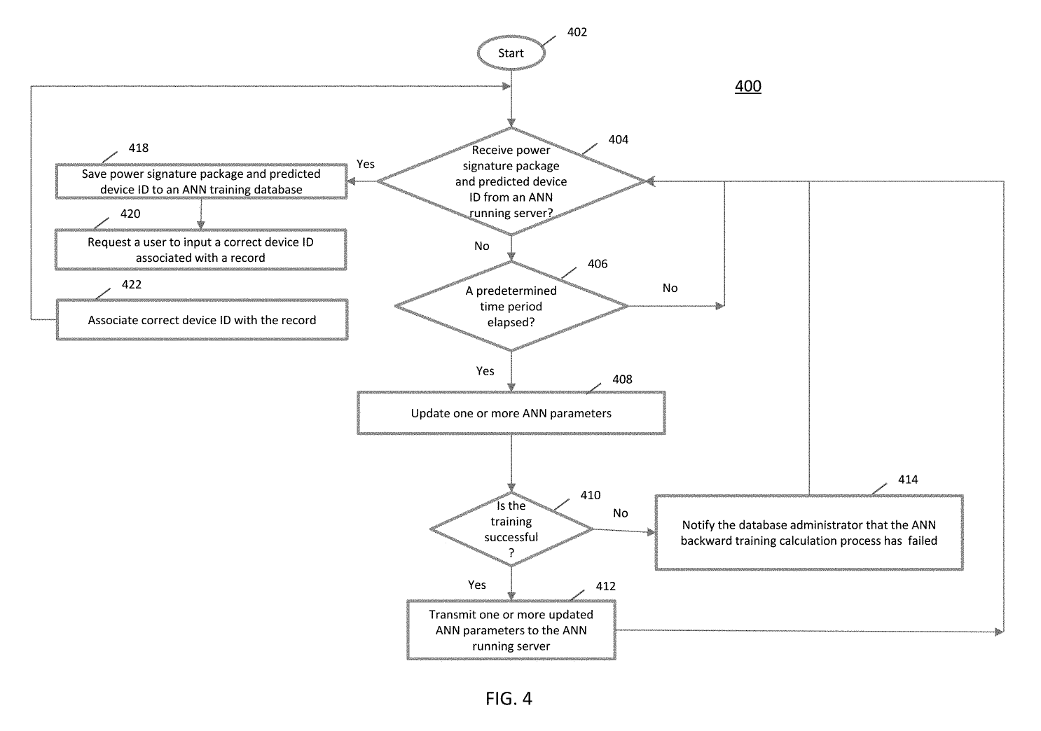

In some embodiments, ANN running server 120 cannot find an existing device ID in the database that corresponds to the power signature received from one or more smart plug devices 117. In these instances, ANN running server 120 may send the received power signature and predicted device ID to an ANN training server 140. In some embodiments, ANN training server 140 updates the ANN implemented by ANN running server 120 based on the power signature and predicted device ID, as described with respect to FIG. 4. By updating the ANN, ANN training server 140 may improve the accuracy of the ANN such that the ANN running server 120 will generate a predicted device ID that can be found in the database for an electrical load device that previously could not be identified.

Further, ANN running server 120 can communicate analysis results in a cloud-based display that is accessible to users via network 123 (e.g., the Internet). For example, users can view the analysis results in cloud-based display via a mobile device 128 or a laptop or desktop computer 126 connected to network 123. In another example, users can view analysis results on a local display 112 directly connected to ANN running server 120.

The example of FIG. 1 can illustrate an exemplary system for implementing an electrical device recognition system. Referring to FIG. 1, the system 100 can include electrical load devices 130, power signature generators 200A-D that capture power information from electrical devices or appliances that are plugged into or connected to smart plug devices 117. Smart plug devices 117 can send power signature data via wireless signal to an ANN running server 120 that is connected to an ANN training server 140 as well as monitoring devices both hard wired for local display 112 and via internet connection for remote display on desktop or laptop computers 126 or mobile devices 128 that are connected to the internet.

FIG. 2 illustrates a flow chart of a method 200 for generating a power signature, according to some embodiments. In some embodiments, method 200 is performed by a power signature generator such as any of power signature generators 200A-D from FIG. 1. The power signature generator may be implemented within a smart plug device, such as one of smart plug devices 117, that electrically couples an electrical load device, such as electrical load devices 130, to a power source. In some embodiments, the power signature generator includes a set of computer program instructions that when executed by one or more processors of the smart plug device causes the one or more processors to perform the steps of method 200. Method 200 starts in step 202.

In step 204, a power signature generator checks a status of the relay (SOR) controlling the electrical load device electrically coupled to the smart plug device.

In step 206, the power signature generator determines whether the SOR is ON indicating that the electrical load device is in an active state and consuming electric power. If the SOR is not ON, i.e., it is OFF, method 200 proceeds to step 204. If the SOR is ON, method proceeds to step 208.

In step 208, the power signature generator samples a plurality of power properties representing a power signature of the electrical load device. In some embodiments, as the electrical load device consumes power from the power source, the power signature generator detects and reads a plurality of power properties including, for example, a voltage, an amperage, a power factor, a power frequency, or a combination thereof. For example, as is well understood by a person skilled in the art, the power signature generator may not need to detect a power value as the power value can be generated based on the amperage and voltage values.

In some embodiments, the power signature generator samples one or more of the power properties according to a respective sampling time period (STP). For example, the power signature generator may sample consumed power for a STP of every 120 seconds. The STP of other power properties may have STPs that is the same as or different from the STP for sampled power.

In some embodiments, within a STP for a power property, the power signature generator samples the power property to generate a sampling segment number (SSN) of samples. The SSN for example may be, but is not limited to, two samples. The power signature generator can generate a sample at a given interval or segment sampling time interval (STIn where n is the segment number) to ensure a meaningful capture of the power property such that the sample is statistically significant. In the example where the SSN is two, the STIn for example may be STI1=10 milliseconds and STI2=1 second. Therefore, in some embodiments, the power signature generator samples a plurality of groups of power properties with each group being associated with a time interval, e.g., STIn, or an indication of time, e.g., a timestamp. As an example, a group of power properties may include a power value, a voltage value, an amperage value, a power factor, a frequency value, or a combination thereof associated with the ST1 of 10 milliseconds. In another example, another group of power properties may be associated with the ST2 of 1 second.

In step 210, the power signature generator determines whether the STP for the power property has elapsed. If STP elapsed, method 200 proceeds to step 212. Otherwise, method 200 continues to sample the power property in step 208.

In step 212, the power signature generator transmits to an ANN running server, such as ANN running server 120 of FIG. 1, a power signature package including a plurality of sampled power properties as described with respect to step 208. Then, method 200 proceeds to step 204.

In some embodiments, as described with respect to FIG. 1, an ANN running server implements an ANN to identify an electrical load device based on the power signature package, as described with respect to FIG. 2, received from a smart plug device. FIG. 5 is a diagram showing an example ANN 500 used by the ANN running server to identify the electrical load device coupled to the smart plug device, according to some embodiments.

In some embodiments, ANN 500 implemented by the ANN running server is generated as a graph data structure including nodes 508A-I, often referred to as “neurons.” As shown in ANN 500, input layer 502 includes nodes 508A-C that are each connected to one or more of nodes 508D-H in one or more hidden layer(s) 504. In the example ANN 500, a first hidden layer includes nodes 508D-G and a second hidden layer includes node 508H. Further, one or more nodes, e.g., node 508H and 508G, in hidden layer 504 are connected to nodes, e.g., node 508I, in output layer 506. In general, the ANN running server may propagate values from input layer 502 to hidden layer(s) 504 and to output layer 506 to generate a predicted device ID representative of the electrical load device.

In some embodiments, the ANN running server inputs the plurality of power parameters in a received power signature package into one or more nodes 508A-C in input layer 502. In some embodiments, the ANN running server inputs a plurality of samples of a power parameter into input layer 502 where the plurality of samples correspond to values captured by a smart plug device at a plurality of time intervals. For example, the ANN running server may receive a power signature package including sampled power values of an electrical load device at 10 millisecond, 1 minute, and 2 minutes. As shown in ANN 500, the ANN running server inputs the three sampled power values into nodes 508A-C of input layer 502, respectively.

In some embodiments, the ANN running server propagates values received at input layer 502 to a first layer of nodes in hidden layer 504 according to established connections between the nodes and according to weights associated with those connections. For example, node 508A is connected to nodes 508D-G with each of those connections being associated with a weight.

In some embodiments, one or more nodes in hidden layer 504 and output layer 506 may each receive weighted values from nodes in a previous layer (e.g., input layer 502 or a previous hidden layer 504). In some embodiments, upon receiving weighted values, a node sums the received weighted values and applies an activation function to the sum to generate an output in a standardized format. In some embodiments, to generate the output in the standardized format, a node may instead apply an activation function to each of the received weighted values before summing the weighted values transformed by the activation function. In some embodiments, the activation function can be a linear, sigmoid, hyperbolic tangent, or step-wise function. For example, a sigmoid activation function may be

$${x}_{j} = f ( z ) = \frac{1}{1 + {e}^{- z}}$$

where z is the input to the activation function.

As an example, node 508D may receive weighted values from nodes 508A-C as shown by the connections between nodes 508A-C and node 508D. Upon generating a standardized output using, for example, a sigmoid activation function, node 508D may apply a weight, e.g., multiple by a value between 0 and 1, to the output for transmitting to other nodes, such as node 508H. Each of the nodes 508D-508H in hidden layer 504 and node 508I in output layer 506 may operate in a similar manner.

In some embodiments, node 508I generates a predicted device ID, e.g., a float number 83.9, by applying an activation function to weighted values received from nodes 508H and 508G. In some embodiments, the ANN running server determines whether the predicted device ID is within a threshold, e.g., 0.3, of a device ID stored in a database storing a plurality of device IDs. For example, the database may store a device ID of 84, which is within the threshold 0.3 of the predicted device ID of 83.9. Therefore, the ANN running server may successfully query the database for a device ID of 84. In some embodiments, the ANN running server queries the database for device IDs that are the closest integer values to the predicted device ID within the threshold. Upon successfully querying the device ID of 84, the ANN running server may identify the electrical load device as a device associated with device ID.

In some embodiments, the database stores device information in association with each of the device IDs. For example, the device information may include a type of the device, a manufacturer of the device, a model number of the device, specifications of the device, an ENERGY STAR status, an annual energy consumption value, an annual CO2 emissions value, or a combination thereof. Based on this stored information, the ANN running server may generate a report to transmit to a user of the electrical load device. As an example, the report may indicate that the device associated with device ID 84 is a Dell Vostro laptop made in 2012, has a rating power of 45 W, is not ENERGY STAR rated, has an annual energy consumption of 165 kWh, has an annual CO2 emission of 188 lbs, among other types of device information.

In some embodiments, as described with respect to FIG. 4, an ANN training server may utilize an ANN backward training process that uses previous predictions of device IDs to refine the weights between pairs of nodes 508A-I. By enabling ANN 500 to “learn” from past estimations of device IDs, ANN 500 can become more accurate in estimating the device IDs of future electrical load devices.

FIG. 3 illustrates a flowchart of a method 300 for using an artificial neural network (ANN) to identify electrically-coupled electrical load devices, according to some embodiments. In some embodiments, the server implements the ANN including a plurality of input nodes connected to one or more output nodes via a plurality of hidden nodes, as described with respect to FIG. 5. In some embodiments, method 300 is performed by a server implementing the ANN, such as ANN running server 120 from FIG. 1. In some embodiments, the server includes a set of computer program instructions that when executed by one or more processors cause the one or more processors to perform the steps of method 300. For ease of explanation, reference may be made to ANN 500 as described with respect to FIG. 5. Method 300 starts at step 302.

In step 304, the server determines whether updates to the ANN are received. For example, the server may receive updates to the ANN from an ANN training server such as ANN training server 140 of FIG. 1, further described with respect to FIG. 4. In some embodiments, method 300 proceeds to step 318 if updates are received. Otherwise, method 300 proceeds to step 306.

In step 318, the server updates one or more ANN parameters based on the updates received in step 304. In some embodiments, an ANN parameter includes a number of hidden layers, a number of nodes within one or more hidden layers, a type of activation function in nodes of the hidden and output layers, or a weight between a pair of nodes being updated. For example, in reference to ANN 500, the number of hidden layers may be changed from 2 to 3; the number of nodes within each hidden layer may be increased to 6060; and the activation function in the hidden layer 504 and output layer 506 may be updated to a Sigmoid Symmetric function. Then, method 300 proceeds to step 304.

In step 306, the server determines whether a power signature package is received from a smart plug device, such as from one of smart plug devices 117 of FIG. 1. Upon determining that no power signature package is received, method proceeds to step 304. Otherwise, method 300 proceeds to step 308.

In some embodiments, the power signature package includes a plurality of power properties generated by a power signature generator, such as any of power signature generators 200A-D, within the smart plug device. The plurality of power properties may be associated with an electrical load device electrically coupled to the smart plug device.

In some embodiments, the plurality of power properties includes a plurality of groups of power properties with each group being associated with a time interval or an indication of a time. As described with respect to FIG. 2, each group of power properties may include a power value, a voltage value, an amperage value, a power factor, a frequency value, or a combination thereof associated with the corresponding time interval or the corresponding indication of the time.

In step 308, the server inputs a plurality of power properties (from the power signature package of step 306) into the ANN to generate a predicted device ID. For example, the server performs this ANN forward prediction calculation, as described with respect to FIG. 5, to obtain a predicted device ID of the electrical load device connected to the smart plug device. As discussed with respect to FIG. 5, the server may assign one or more of the power properties to nodes 508A in input layer 502. Then, the server may propagate weighted outputs of input layer 502 to nodes 508D-G in hidden layer(s) 504 whose outputs are weighted and received by node 508H in output layer 506 to generate the predicted device ID.

In step 309, the server queries a database storing a plurality of device IDs for a device ID that is within a threshold of the predicted device ID. In some embodiments where the predicted device ID is a float value, the server queries the database for a device ID that is the closest integer value (i.e., a number without a decimal point) of the float integer. In some embodiments, the server queries the database for one or more device IDs that is within a range of values as defined by a lower limit and an upper limit. For example, as discussed in FIG. 5, the predicted device ID may be 83.9. In this example, the lower limit may be 81.5 and the upper limit may be 84.2 in which case the server may query the database for one or more of device IDs 82, 83, and 84.

In step 310, the server determines whether the device ID queried in step 309 exists. If the value does not exist, then the server determines that the predicted device ID is not within a valid range of values and method 300 proceeds to step 314. Otherwise, method 300 proceeds to step 312.

In step 314, the server transmits one or more power properties from the power signature package (received in 306) and the predicted device ID (predicted in step 308 to the ANN training server. As described with respect to FIG. 4, the ANN training server may update one or more nodes in the ANN or update one or more parameters of the ANN.

In some embodiments, in response to determining that the device ID does not exist in step 310, the server transmit a message to an application operated by the user to request the user to input a correct device ID associated with the electrical load device. Based on the user's inputs, the server may update the database storing device IDs.

In step 312, in response to determining that the queried device ID exists, the server identifies the electrical load device as a device associated with the device ID.

In step 316, the server generates and transmits a report to a user of the electrical load device. In some embodiments, the server transmits the information associated with the device ID from the database in the form of a report to an application for viewing the information. For example, the report may be retrieved by the user via a web browser, a web application, or other types of applications as described with respect to FIG. 1. In some embodiments, the report includes electrical load device information associated with the queried device ID, e.g., 84, stored in the database. For example, the electrical load device information may include, but is not limited to, a device ID, a device type, a device manufacturer, a model number, specifications of the device, or other power properties such as those included in the power signature package of step 306.

In step 317, in response to identifying the electrical load device as being associated with the queried device ID in step 312, the server transmits an operating schedule for the electrical load device. In some embodiments, the server generates the operating schedule based on information associated with the device ID and stored in the database, preferences received from the user of the electrical load device, a history of power signature packages associated with the electrical load device, or a combination thereof.

In some embodiments, the operating schedule include instructions to electrically disconnect and reconnect the electrical load device from and to a power source at a plurality of time intervals, a plurality of indications of future times, or a combination thereof.

FIG. 4 illustrates a flowchart of a method 400 for training an ANN implemented by a server to identify electrically-coupled electrical load devices, according to some embodiments. In some embodiments, an ANN training server, such as ANN training server 140 of FIG. 1, implements the steps of method 400 to train the ANN implemented by an ANN running server, such as ANN running server 120 of FIG. 1. In some embodiments, the ANN training server includes a set of computer program instructions that when executed by one or more processors cause the one or more processors to perform the steps of method 400. For ease of explanation, reference may be made to ANN 500 as described with respect to FIG. 5. Method 400 starts at step 402.

In step 404, the ANN training server receives a power signature package and a predicted device ID from an ANN running server. In some embodiments, step 404 may correspond to step 314 of FIG. 3 where the ANN running server transmits the power signature package and the predicted device ID. Method 400 proceeds to step 418 if the ANN training server receives the power signature package and the predicted device ID. Otherwise, method 400 proceeds to step 406.

In step 418, the ANN training server saves the power signature package and the predicted devices ID to an ANN training database. In some embodiments, the ANN training server marks a record associated with the received power signature package and the predicted device ID as “to be processed”.

In step 420, the ANN training server requests a user to input a correct device ID to associate with the received power signature package of step 404. In some embodiments, the ANN training server notifies a user via a notification or a message sent to a web application or a software system accessible by the user. Once the user verifies and indicates the correct device ID, the web application or the software system transmits the user's inputs to the ANN training server.

In step 422, the ANN training server associates the received, correct device ID with the record described with respect to step 418. In some embodiments, the ANN training server stores the correct ID in the ANN training database. Then, method 400 proceeds to step 404 where the ANN training server checks if there are power signature packages and predicted device IDs received from the ANN running server.

In step 406, the ANN training server determines whether a predetermined time period, for example but not limited to one week, has elapsed. In some embodiments, the predetermined time period is received from a user or generated by the ANN training server based on a length of time to perform step 408 in a previous iteration of method 400 as discussed below. If the predetermined time period has not elapsed, then method 400 proceeds to step 404. Otherwise, method 400 proceeds to step 408 where the ANN training server implements an ANN backward training to update and improve the accuracy of the ANN implemented by the ANN running server. In effect, the ANN training server batches a plurality of records as processed in steps 418-422 for the predetermined period of time before updating the ANN in step 408.

In step 408, the ANN training server updates one or more parameters of the ANN in a backward ANN training calculation process. As described with respect to step 318 in FIG. 3, an ANN parameter that may be updated includes a number of hidden layers, a number of nodes within one or more hidden layers; a type of activation function in nodes of the hidden and output layers, or a weight between a pair of nodes in the graph data structure of the ANN. In some embodiments, the backward ANN training calculation process performed by the ANN training server may involve calculating one or more of the ANN parameters above that reduces the difference between the predicted device ID (received in step 404) and the correct device ID (received in step 420). For example, the ANN training server may be configured to determine one or more ANN parameters that cause the difference to be within a tolerable range.

In step 410, the ANN training server determines whether the training process of step 408, i.e., the ANN back training calculation, is performed successfully. For example, the training process may fail if the ANN training server cannot determine one or more ANN parameters that reduces the difference within the tolerable range or cannot determine the one or more ANN parameters within a predetermined period of time. If the training is unsuccessful, method 400 proceeds to step 414. Otherwise, method 400 proceeds to step 412.

In step 414, the ANN training server notifies a user or a database administrator that the ANN backward training calculation process has failed. In some embodiments, the ANN training server transmits the notification to the user via an automated software system. In some embodiments, the ANN training server may request the user to take corrective actions. Method 400 proceeds to step 404.

In step 412, upon determining that the training process is successful in step 410, the ANN training server transmits one or more updated ANN parameters to the ANN running server. In some embodiments, these updated ANN parameters are received by the ANN running server in step 304 as described with respect to FIG. 3.

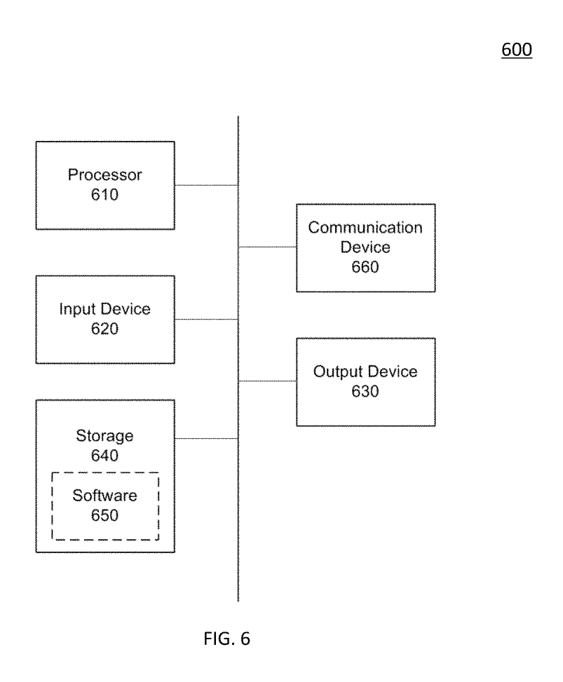

FIG. 6 illustrates an example of a computing device in accordance with one embodiment. Device 600 can be a host computer connected to a network. Device 600 can be a client computer or a server. As shown in FIG. 6, device 600 can be any suitable type of microprocessor-based device, such as a personal computer, work station, server, or handheld computing device portable electronic device, such as a phone or tablet. Device 600 can include, for example, one or more of processor 610, input device 620, output device 630, storage 640, and communication device 660. Input device 620 and output device 630 can generally correspond to those described above and can either be connectable or integrated with the computer.

Input device 620 can be any suitable device that provides input, such as a touchscreen, keyboard or keypad, mouse, or voice-recognition device. Output device 630 can be any suitable device that provides output, such as a touchscreen, haptics device, or speaker.

Storage 640 can be any suitable device that provides storage, such as an electrical, magnetic, or optical memory, including a RAM, cache, hard drive, or removable storage disk. Communication device 660 can include any suitable device capable of transmitting and receiving signals over a network, such as a network interface chip or device. The components of the computer can be connected in any suitable manner, such as via a physical bus or wirelessly.

Software 650, which can be stored in storage 640 and executed by processor 610, can include, for example, the programming that embodies the functionality of the present disclosure (e.g., as embodied in the devices described above).

Software 650 can also be stored and/or transported within any non-transitory, computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 640, that can contain or store programming for use by or in connection with an instruction-execution system, apparatus, or device.

Software 650 can also be propagated within any transport medium for use by or in connection with an instruction-execution system, apparatus, or device, such as those described above, that can fetch instructions associated with the software from the instruction-execution system, apparatus, or device and execute the instructions. In the context of this disclosure, a transport medium can be any medium that can communicate, propagate, or transport programming for use by or in connection with an instruction-execution system, apparatus, or device. The transport readable medium can include, but is not limited to, an electronic, magnetic, optical, electromagnetic, or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has made reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments, with various modifications, that are suited to the particular use contemplated.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A system for identifying electrical load devices, comprising:
a memory for storing:
a graph that implements an artificial neural network (ANN), and
a database comprising a plurality of device identifications (IDs); and
one or more processors, the one or more processors configured to:
receive a plurality of power properties from a smart plug device, wherein the plurality of power properties are associated with an electrical load device electrically coupled to the smart plug device;
input the plurality of power properties into a plurality of nodes of the graph to generate a predicted device ID;
query the database for a device ID that is within a threshold of the predicted device ID, wherein the device ID is queried from the plurality of device IDs;
determine whether the device ID exists in the database based on the querying; and
in response to determining that the device ID exists, identify the electrical load device as a device associated with the device ID.

2. The system of claim 1, wherein the plurality of power properties comprises a plurality of groups of power properties with each group being associated with a time interval or an indication of a time, wherein each group includes a power value, a voltage value, an amperage value, a power factor, a frequency value, or a combination thereof associated with the corresponding time interval or the corresponding indication of the time.

3. The system of claim 1, wherein the plurality of power properties includes power properties associated with a plurality of time intervals, a plurality of indications of times, or a combination thereof.

4. The system of claim 1, wherein the one or more processors are configured to:
input the plurality of power properties into a plurality of nodes of the graph; and
propagate values generated by the plurality of nodes through a plurality of hidden nodes in the graph to generate the predicted device ID.

5. The system of claim 1, wherein the database stores information associated with the device identified by the device ID, and wherein the information includes a type of the device, a manufacturer of the device, a model number of the device, specifications of the device, an ENERGY STAR status, an annual energy consumption value, an annual CO2 emissions value, or a combination thereof.

6. The system of claim 5, wherein the one or more processors are configured to:
in response to identifying the electrical load device as the device associated with the device ID, transmit the information associated with the device ID from the database to an application for viewing the information.

7. The system of claim 5, comprising:
in response to identifying the electrical load device as the device associated with the device ID, determine an operating schedule for controlling the electrical load device based on the information associated with the device ID; and
transmit the operating schedule to the smart plug device.

8. The system of claim 7, wherein the operating schedule comprises instructions to electrically disconnect and reconnect the electrical load device from and to a power source at a plurality of time intervals, a plurality of indications of future times, or a combination thereof.

9. The system of claim 1, wherein the one or more processors are configured to:
in response to determining that the device ID does not exist, transmit the predicted device ID and the plurality of power properties to a training server for updating one or more nodes in the graph.

10. The system of claim 1, wherein the one or more processors are configured to:
in response to determining that the device ID does not exist, transmit a message to an application to request a user operating the application to input a device ID associated with the electrical load device.

11. A method for identifying electrical load devices at a server, comprising:
providing a graph that implements artificial neural networks (ANN);
receiving a plurality of power properties from a smart plug device, wherein the plurality of power properties are associated with an electrical load device electrically coupled to the smart plug device;
inputting the plurality of power properties into the graph to generate a predicted device ID;
querying a database comprising a plurality of device identifications (IDs) for a device ID that is within a threshold of the predicted device ID;
determining whether the device ID exists in the database based on the querying; and
in response to determining that the device ID exists, identifying the electrical load device as a device associated with the device ID.

12. The method of claim 11, wherein the plurality of power properties comprises a plurality of groups of power properties with each group being associated with a time interval or an indication of a time, wherein each group includes a power value, a voltage value, a current value, a power factor, a frequency value, or a combination thereof associated with the corresponding time interval or the corresponding indication of the time.

13. The method of claim 11, wherein the plurality of power properties includes power properties associated with a plurality of time intervals, a plurality of indications of times, or a combination thereof.

14. The method of claim 11, wherein the database stores information associated with the device identified by the device ID, and wherein the information includes a type of the device, a manufacturer of the device, a model number of the device, specifications of the device, an ENERGY STAR status, an annual energy consumption value, an annual CO2 emissions value, or a combination thereof.

15. The method of claim 14, comprising:
in response to identifying the electrical load device as the device associated with the device ID, transmitting information associated with the device ID from the database to an application for viewing the information.

16. The method of claim 14, comprising:
in response to identifying the electrical load device as the device associated with the device ID, determining an operating schedule for controlling the electrical load device based on the information associated with the device ID; and
transmitting the operating schedule to the smart plug device.

17. The method of claim 16, wherein the operating schedule comprises instructions to electrically disconnect and reconnect the electrical load device from and to a power source at a plurality of time intervals, a plurality of indications of future times, or a combination thereof.

18. The method of claim 11, comprising:
in response to determining that the device ID does not exist, transmitting the predicted device ID and the plurality of power properties to a training server for updating one or more nodes in the graph.

19. The method of claim 11, comprising:
in response to determining that the device ID does not exist, transmitting a message to an application to request a user operating the application to input a device ID associated with the electrical load device.

20. A device for identifying electrical load devices, the device comprising:
a power socket that provides power from a power source to an electrical load device electrically coupled to the power socket;
one or more sensors that detect a plurality of properties associated with the power consumed by the electrical load device; and
one or more processors, the one or more processors configured to:
receive the plurality of properties detected by the one or more sensors;
transmit the plurality of properties to a server;
receive an operating schedule from the server, the operating schedule comprising instructions to electrically disconnect and reconnect the electrical load device from the power source at a plurality of time intervals, a plurality of indications of future times, or a combination thereof; and
disconnect and reconnect the electrical load device from and to the power source based on the operating schedule.
